(19) United States
(12) Patent Application Publication
(10) Pub. No.: US 2025/0240173 A1
(43) Pub. Date: Jul. 24, 2025

(54) DIGITAL SIGNATURE SYSTEM

(71) Applicant: NEC Corporation, Tokyo (JP)

(72) Inventors: Hiroto TAMIYA, Tokyo (JP); Saki OTSUKI, Tokyo (JP); Yoshitomo WARASHINA, Tokyo (JP); Toshiyuki ISSHIKI, Tokyo (JP)

(73) Assignee: NEC Corporation, Tokyo (JP)

(21) Appl. No.: 19/011,894

(22) Filed: Jan. 7, 2025

(30) Foreign Application Priority Data
Jan. 18, 2024 (JP) 2024-005829

(51) Int. Cl. H04L 9/32; H04L 9/08

(52) U.S. Cl. CPC H04L 9/3247; H04L 9/0866; H04L 9/3263

(57) ABSTRACT

An certificate issuer generates auxiliary data using a signing key and first biometric information, generates a certificate including a verification key corresponding to the signing key, and transmits the certificate and the auxiliary data to a certificate holder, which obtains the second biometric, receives the certificate and the auxiliary data transmitted from the certificate issuer, generates, using the second biometric information and the auxiliary data, a signature, and transmit a certificate presentation and the signature to a certificate verifier, which receives the certificate presentation and the signature from the certificate holder and verifies the signature using the verification key include d in the certificate.

### CROSS REFERENCE TO RELATED APPLICATIONS

This application is based upon and claims the benefit of the priority of Japanese patent application No. 2024-005829, filed on Jan. 18, 2024, the disclosure of which is incorporated herein in its entirety by reference thereto.

### FIELD

This disclosure relate s to a verifiable certificate system, a method, and a non-transitory computer readable medium.

### BACKGROUND

Regarding a verifiable certificate system, reference may be made, for example, to FIG. 1A (Non-Patent Literature (NPL) 1, FIG. 1. The roles and information flows forming the basis for this specification). A Verifiable Credential (VC) may be said to be a digital certificate that digitalizes information representing properties of an individual and so forth that physically exist, such as driver's licenses, academic credentials, credentials, or other confidential data, to allow online verification (cryptographical verification) thereof. A “Verifiable Credential” may be also denoted as a “certificate (VC)”, or simply abbreviated as “VC”. A certificate (VC) allows users to secure and share proof of their qualifications, memberships, and competencies through a digitally verifiable format. For example, when a user uses various services of an application (s), the user presents a certificate (VC), and the application validates whether the user meets a condition(s) to grant a permission to the user for using the service(s). Generally, a certificate (VC) certifying a user's attribute(s) is issued by a specific issuer (e.g., university, bank, government, etc.).

An issuer makes a claim(s) on one or more subjects (thing about which the claim is made), creates a certificate (VC) from the claim (s), and transmits the certificate (VC) to a holder.

The holder possesses one or more VCs and generates a Verifiable Presentation (VP). The holder is usually a subject of the VC it holds. “Verifiable Presentation” may be also denoted or simply abbreviated as “Certificate Presentation (VP)” or “VP”.

A certificate presentation (VP) can be said to be data derived from one or more certificates (VCs) issued by one or more issuers. A VP may be generated in response to a challenge from a verifier to prevent reuse thereof.

A verifier verifies a VP received from the holder. The verifier verifies, for example, a signature attached on the certificate (VC) in the VP with an issuer's verification key (public key) to confirm that the contents of the certificate (VC) have not been tampered with. The verifier obtains a verification key of the holder and verifies the signature on the certificate presentation (VP) to confirm that the contents of the VP have not been tampered with.

When the holder does not want other party/ies to know contents of information, and only wants the other party/ies to know that the holder has the information that meets the condition(s), Zero-Knowledge Proof (ZKP) is used to verify that the information presented meets the condition(s) and that the information is a certificate (VC) issued by a trusted issuer. The issuer, holder, and verifier may each be implemented as information processing apparatus equipped with communication functions.

In FIG. 1A, a verifiable data registry manages data necessary for the system to use the certificate (VC), such as a schema of the certificate (VC) and a public key of the issuer. The verifiable data registry may include a trusted database, a distributed database, a government identity database, a distributed ledger and so forth.

FIG. 1B illustrates the elements of a certificate (VC) (Non-Patent Literature: 1 § 3.2 Credentials, FIG. 5 Basic components of a verifiable credential).
Credential Metadata: Metadata indicating the issuer, date and time of issuance, etc.;
Claim(s): Contents of the proof that the certificate provides; and
Proof(s): Digital signature of the issuer, etc.

FIG. 1C illustrates the elements of a Verifiable Presentation (Certificate Presentation) (VP) (Non-Patent Literature 1 § 3.3 Presentations, FIG. 7 Basic components of a verifiable presentation). The certificate Presentation (VP) is a data format for presenting a certificate to a verifier.
Presentation Metadata: Metadata indicating the presenter, date and time of issuance, etc.;
Verifiable Credential(s): VC to be presented;
Proof(s): Digital signature indicating that a creator is the holder, etc.

Verification of the certificate presentation (VP) may be performed based on, for example, Non-Patent Literature 1 (§ 3.3 Presentations, FIG. 8 Information graphs associated with a basic verifiable presentation) and Reference Literature 1.

A signature of the issuer may be attached on the certificate (VC). A signature of the holder may be attached on the certificate presentation (VP). The verifier may obtain verification keys of the issuer and the holder from, for example, a public repository and verify signatures to verify contents of the certificate (VC) and the issuer, and contents of the certificate presentation (VP) and the holder (presenter).
NPL 1: Verifiable Credentials Data Model v1.1 (w3.org): § 1. Introduction to § 3. Core Data Mode SUMMARY

Assuming a system in which biometric information is presented to the verifier as part of the certificate (VC) and verified against the biometric information obtained by the verifier to verify identity, there is a possibility of leakage or compromise such as breaking confidentiality, integrity, or availability of biometric information on the verifier's side, since the verifier handles biometric information (biometric signature).

One of objects of the present disclosure is to disclose a verifiable certificate system, method, and non-transitory computer readable medium, each enabled to improve security by avoiding a possibility of leakage or compromise of biometric information.

According to at least one of modes or embodiments of the present disclosure, a verifiable certificate system includes a certificate issuer, a certificate holder, and a certificate verifier.

The certificate issuer includes a communication interface configured to communicate at least with the certificate holder; a memory configured to store instructions; and a processor configured to execute the instructions to generate first auxiliary data using a first signing key and first biometric information, generate a certificate including a verification key corresponding to the first signing key, and transmit the certificate and the first auxiliary data to the certificate holder.

The certificate holder includes a communication interface configured to communicate at least with the certificate issuer and the certificate verifier; a memory configured to store instructions; and a processor configured to execute the instructions to acquire second biometric information, receive the certificate and the first auxiliary data transmitted from the certificate holder, generate a signature using the second biometric information and the first auxiliary data, and generate a certificate presentation using the certificate to send the certificate presentation and the signature to the certificate verifier.

The certificate includes a communication interface configured to communicate at least with the certificate holder; a memory configured to store instructions; and a processor configured to execute the instructions to receive the certificate presentation and signature transmitted from the certificate holder, verify the certificate included in the certificate presentation, and verify the signature using the verification key included in the certificate.

According to at least one of modes or embodiments of the present disclosure, a method of verification for a verifiable certificate system including a certificate issuing node, a certificate holding node, and a certificate verifying node, includes, by the certificate issuing node:
generating first auxiliary data using a first signing key and first biometric information;
generating a certificate including a verification key corresponding to the first signing key; and
transmitting the certificate and the first auxiliary data are sent to the certificate holding node.

The method includes, by the certificate holding node: obtaining second biometric data; receiving the certificate and the first auxiliary data transmitted from the certificate holding node; generating a signature using said second biometric information and said first auxiliary data;
generating a certificate presentation using the certificate; and
transmitting the certificate presentation and signature to the certificate verifying node.

The method further includes, by the certificate verifying node:
receiving the certificate presentation and signature transmitted from the certificate holding node;
verifying the certificate included in the certificate presentation; and
verifying the signature using the verification key included in the certificate.

According to at least one of modes or embodiments of the present disclosure, there is disclosed a non-transitory computer readable recording medium storing one or more programs that cause at least the first through third processing apparatuses to perform processing of a certificate issuer, a certificate holder, and a certificate verifier included in a system, wherein the processing, by the first processing apparatus, includes:
generating first auxiliary data using a first signing key and first biometric information;
generating a certificate including a verification key corresponding to the first signing key; and
transmitting the certificate and the first auxiliary data to the second processing apparatus,
wherein the processing, by the second processing apparatus, includes:
obtaining second biometric information;
generating a signature using the second biometric information and the first auxiliary data;
generating a certificate presentation from the certificate; and transmitting the certificate presentation and the signature to the third processing apparatus, and
wherein the processing, by the third processing apparatus, including:
verifying the certificate from the certificate presentation; and verifying the signature using the verification key included in the certificate.

According to the present disclosure, a possibility of leakage compromise of biometric information can be avoided to improve security.

### BRIEF DESCRIPTION OF DRAWINGS

FIGS. 1A to 1C illustrate related technologies.

FIG. 2 illustrates a system of at least one of example embodiments of the present disclosure.

FIG. 3 illustrates a configuration example of each apparatus in an example system of at least one of example embodiments.

FIG. 4 illustrates an example of a processing step of an example system of at least one of example embodiments.

FIG. 5 illustrates an example of the calculation process of an example system of at least one of example embodiments.

FIG. 6 illustrates an example of a computation process of an example system of at least one of example embodiments.

FIG. 7 illustrates an example of the calculation process of the example system of at least one of example embodiments.

FIGS. 8A and 8B illustrate computer implementation examples of at least one of example embodiments.

### EXAMPLE EMBODIMENTS

In the following description of example embodiments, reference is made to the accompanying drawings in which it is shown by way of illustration specific examples that can be practiced. It is to be understood that other examples can be used and structural changes can be made without departing from the scope of the various examples. It is noted that in the present disclosure, the expression “at least one of A and B” means A, B, or (A and B). The term expressed as “-(s)” includes both singular and/or plural form. According to example embodiments of the present disclosure, an issuer may be configured to generate a certificate (Verifiable Credential: VC) including a public key, generate auxiliary data that enables generation of a signature only when biometric information of the same person as biometric information presented is given, and transmit the certificate (VC) and the auxiliary data to a holder. A holder may be configured to generate a certificate presentation (Verifiable Presentation: VP) using the certificate (VC) received from the issuer, generate a signature, using the biometric information presented and the auxiliary data to transmit the certificate presentation (VP) and the signature to a verifier. The verifier may be configured to verify the certificate presentation (VP) and the signature. Verification of the certificate presentation (VP) may include verification of the certificate (VC) included in the certificate presentation (VP).

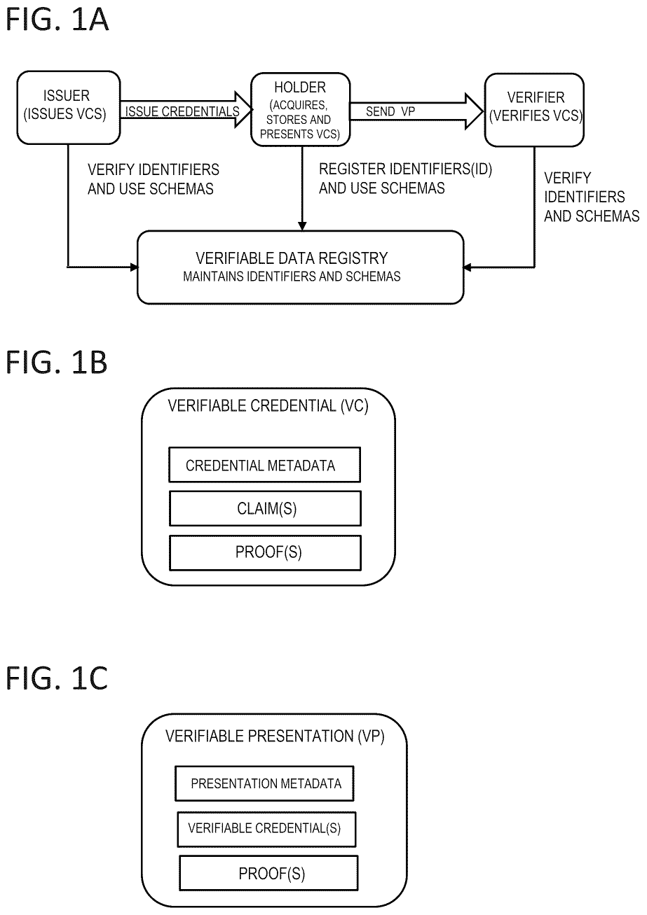

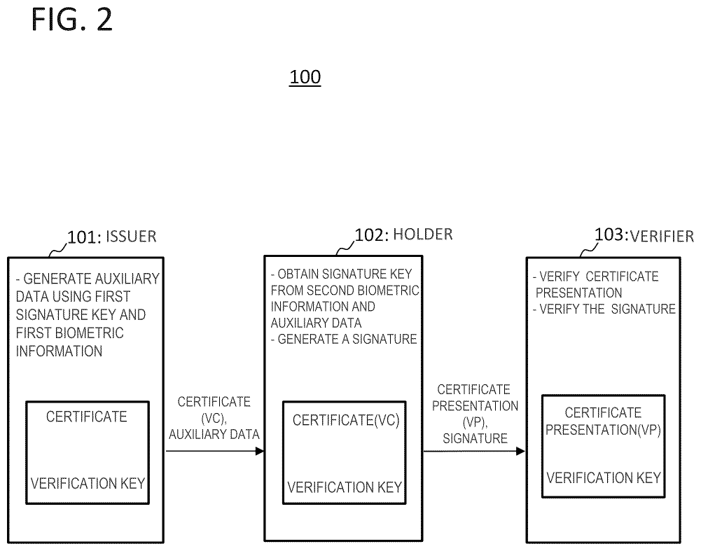

FIG. 2 schematically illustrates an example certificate verification system 100 of at least one of the example embodiments of present disclosure. In FIG. 2, the verifiable data registry in FIG. 1A is omitted and the description of the verifiable data registry is omitted the same applies to the following drawings.

Referring to FIG. 2, an issuer (certificate issuer) 101 is configured to generate auxiliary data from first biometric information w and generates a signing key (private key). The auxiliary data may be data that enables signature generation when second biometric information w′ of the same person as the first biometric information w used for generation of the auxiliary data is given. The auxiliary data may be a sketch such as a secure sketch, a linear sketch, a key parameter for a biometric-based distributed signature, helper key, etc. A verification key (public key) corresponding to the signing key may be included in the certificate (VC). The auxiliary data also may be included in the certificate (VC).

The holder (certificate holder) 102 is configured to perform signature generation process using the second biometric w′ and the auxiliary data. A signature can be generated using the signing key corresponding to the verification key included in the certificate (VC) only when the second biometric w′ of the same person as the first biometric information w′ used to generate the auxiliary data is presented. The holder 102 is configured to create a certificate presentation (VP) using the certificate (VC) received from the issuer 101. The holder 102 is configured to invariably include the verification key in the certificate presentation (VP). The holder 102 may include the generated signature in the certificate presentation (VP). Alternatively, the holder 102 may transmit the generated signature and the certificate presentation (VP), separately or simultaneously.

A verifier (certificate verifier) 103 is configured to verify the certificate presentation (VP). The verifier 103 may verify that the verification key was issued for the certificate (VC). The verifier 103 may verify the signature subsequently. That the signature can be generated using the private key corresponding to the verification key indicates that it is possible to verify the first biometric information w presented at the time of issuance of the certificate (VC) and the second biometric information w′ presented at the time of generation of the certificate presentation (VP) are those of the same person.

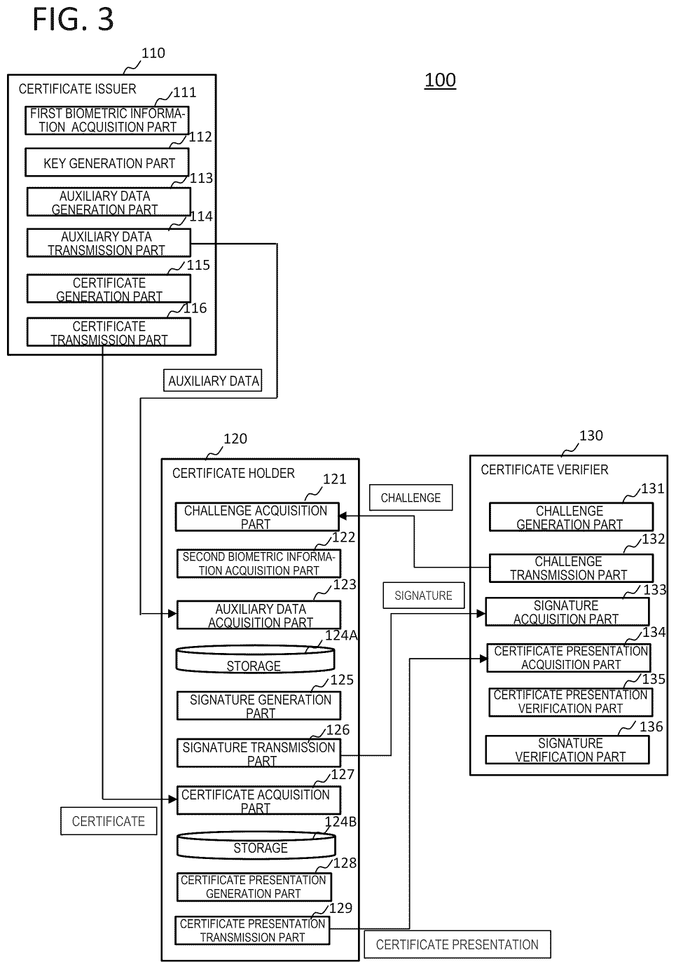

FIG. 3 illustrates an example configuration of each element of the certificate verification system 100 described with reference to FIG. 2. The issuer 101, holder 102, and verifier 103 are each implemented as a certificate issuer 110, certificate holder 120, and certificate verifier 130, each of which may be made of information processing apparatuses, each including at least a processor, a memory and a communication interface (each not shown) and configured to communicatively connect with an opposing node(s) via a network(s) (not shown).

The certificate issuer 110 includes a first biometric information acquisition part 111, a key generation part 112, an auxiliary data generation part 113, an auxiliary data transmission part 114, a certificate generation part 115, and a certificate transmission part 116. Processing of each of these parts may be realized by a hardware of the information processing apparatus, a program (software) module executed by the processor, and/or combination thereof.

The certificate holder 120 includes a challenge acquisition part 121, a second biometric information acquisition part 122, an auxiliary data acquisition part 123, a storage 124A, a signature generation part 125, a signature transmission part 126, a certificate acquisition part 127, a storage 124B, a certificate presentation generation part 128, and a certificate presentation transmission part 129. Processing of each of these parts may be realized by a hardware of the information processing apparatus, a program (software) module executed by the processor, or combination thereof.

The certificate verifier 130 includes a challenge generation part 131, a challenge transmission part 132, a signature acquisition part 133, a certificate presentation acquisition part 134, a certificate presentation verification part 135, and a signature verification part 136. Processing of each of these parts may be realized by a hardware of the information processing apparatus, a program (software) module executed by the processor, or combination thereof.

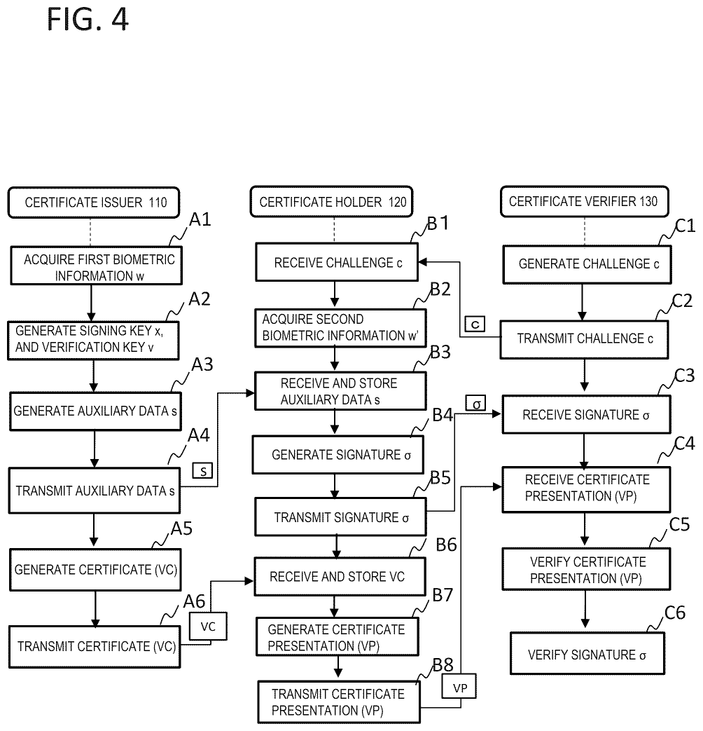

FIG. 4 illustrates a processing flow of the certificate verification system 100 of FIG. 3. Referring to FIG. 4, in the certificate issuer 110, the first biometric information acquisition part 111 acquires the first biometric information w of the user from a sensor or the like now shown (Step A1). The key generation part 112 generates a pair of a signing key (private key) x and a verification key (public key) v (Step A2). The auxiliary data generation part 113 generates auxiliary data s using the first biometric information w and the signing key x (Step A3). The auxiliary data transmission part 114 transmits the auxiliary data s to the certificate holder 120 (Step A4). The certificate generation part 115 generates the certificate (VC) illustrated in FIG. 1B (Step A5). The certificate generation part 115 may include the verification key v in the claim(s) of the certificate (VC). The certificate transmission part 116 transmits the certificate (VC) including the verification key v to the certificate holder 120 (Step A6). The auxiliary data s may be included in the claim(s) of the certificate (VC).

In the certificate holder 120, the challenge acquisition part 121 acquires a challenge c transmitted from the certificate verifier 130 (Step B1). The second biometric information acquisition part 122 acquires the second biometric information w′ from a sensor or the like (not shown) (Step B2). The auxiliary data acquisition part 123 receives the auxiliary data s transmitted from the certificate issuer 110 and stores it in the storage 124A (Step B3). The signature generation part 125 restores (recovers) the signing key x′ using the second biometric information w′ and the auxiliary data s (which is generated based on the first biometric information w and the signing key x) and generates a signature a for the challenge c using the restored signing key x′ (Step B4).

In the certificate holder 120, the signature transmission part 126 transmits the generated signature a to the certificate verifier 130 (Step B5). The certificate acquisition part 127 receives the certificate (VC) transmitted from the certificate issuer 110 and stores it in the storage 124B (Step B6). The certificate presentation generation part 128 generates the certificate presentation (VP) illustrated in FIG. 1C using the certificate (VC) (including the verification key v in the claim) transmitted from the certificate issuer 110 (Step B7). The certificate presentation transmission part 129 transmits the generated certificate presentation (VP) to the certificate verifier 130 (Step B8). Step B5 may be performed at the same time as step B8. The signature a may be included in the certificate presentation (VP).

In the certificate verifier 130, the challenge generation part 131 generates a challenge (e.g., random number) c (Step C1). The challenge transmission part 132 transmits the challenge c to the certificate holder 120 (Step C2). The signature acquisition part 133 receives the signature a transmitted from the certificate holder 120 (Step C3). The certificate presentation acquisition part 134 receives the certificate presentation (VP) transmitted from the certificate holder 120 (Step C4). The certificate presentation verification part 135 verifies the certificate presentation (VP) (Step C5). The signature verification part 136 verifies the signature using the verification key included in the claim of the certificate (VC) included in the certificate presentation (VP) (Step C6). The verification of the certificate presentation (VP) by the certificate presentation verification part 135 follows the above-mentioned NPL 1, Reference Literature 1, etc. The signature attached on the certificate (VC) (included in the certificate presentation (VP)) by the certificate issuer 110 or the signature attached on the certificate presentation (VP) by the certificate holder 120, which is used to verify the certificate presentation (VP) in the certificate presentation verification part 135, is a signature different from the signature a received in step C3.

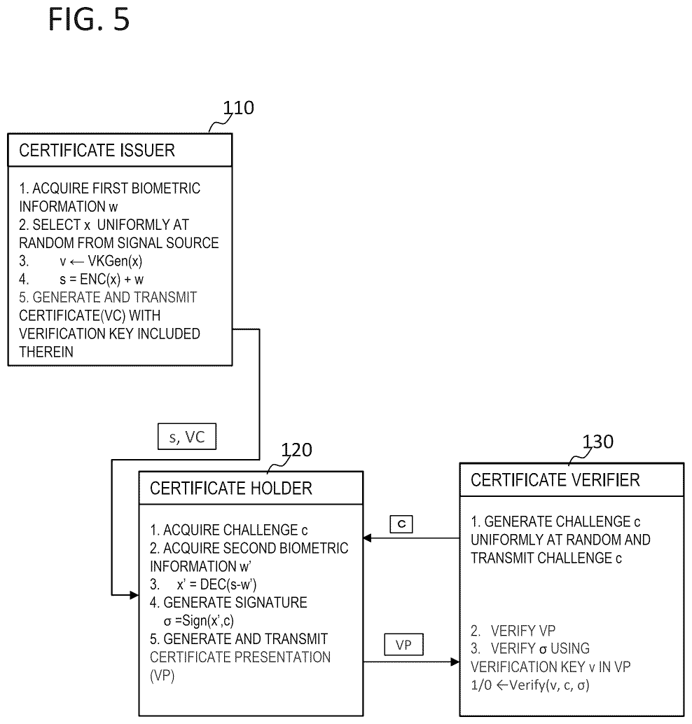

FIG. 5 illustrates a simplified schematic diagram of an example operation process in the system according to the embodiment of the present disclosure. The numbers in each apparatus represent processing steps at each apparatus (not necessarily corresponding to steps at each apparatus described with reference to FIG. 4). In the following, a processing step number at each apparatus in FIG. 5 is added in a parenthesis at an end of a sentence describing a processing at each apparatus.

The certificate issuer 110 obtains the first biometric information w (Step 1). The certificate issuer 110 randomly selects x from an information source to set x as a signing key (secret key) (Step 2) and generates the verification key v corresponding to the signing key x (Step 3). The certificate issuer 110 generates auxiliary data (also may be termed as first auxiliary data) s by combining an encoded key ENC(x) (where x is a signing key (private key) encoded by an encoding function Encode) and the first biometric information w (Step 4).

The auxiliary data s may be obtained by the following Equation (1).

$$s = Encode ( x ) + w \qquad ( 1 )$$

A binary operator + on the right side of Equation (1) is not limited to addition, but may also be subtraction, or bit-wise exclusive OR, etc.

The encoding function Encode converts data (plaintext) m to a code c in an information source space. A decoding function Decode converts the code c back to the data (plaintext) m.

$$c ← Encode ( m ) \qquad ( 2 )$$

$$m ← Decode ( c ) \qquad ( 3 )$$

Here, as for a code c′ whose difference from c, i.e., a code of any plaintext m in the information source space is within a correction capability, the following must hold.

$$m = Decode ( {c}^{′} ) \qquad ( 4 )$$

In the following, a linear cod is used.

### Linearity

$$Encode ( m 1 ) + Encode ( m 2 ) \qquad ( 5 )$$

is a code word for m1+m2, and

$$m 1 + m 2 = Decode ( Encode ( m 1 ) + Encode ( m 2 ) ) \qquad ( 6 )$$

is valid. In Equation (6), the “+” on the left and right sides need not be the same operation.

In the example embodiments, as for coding, for example, error-correcting codes (Hamming codes, BCH (Bose-Chaudhuri-Hocquenghem code) codes, RS (Reed-Solomon) codes, LDPC (low-density parity-check code) codes, etc.) may be used. Alternatively, lattice coding, for example, may be used. More specifically, methods using an integer lattice, triangular lattice, and more complex lattice are known (see Reference Literature 5). Auxiliary data s can also correspond to a secure sketch of Reference Literature 2. Auxiliary data s may correspond to a commitment in which biometric information is embedded in a secret key (see Reference Literature 6).

The certificate issuer 110 generates a certificate (VC) including the verification key in the claim and transmits it to the certificate holder 120 (Step 5).

The certificate holder 120 obtains a challenge generated by the certificate verifier 130 (Step 1). The certificate holder 120 acquires the second biometric information w′ (Step 2).

In the certificate holder 120, the decryption function Decode takes, as input, a difference between the auxiliary data s (=Encode(x)+w) and the second biometric information w′ to the decryption function Decode to restore (recover) the signing key x′.

$${x}^{′} = Decode ( s - {w}^{′} ) \qquad ( 7 )$$

Let's look at the right side of Equation (7),

$$Decode ( s - {w}^{′} ) = Decode ( ( Encode ( x ) + w ) - {w}^{′} ) = Decode ( Encode ( x ) + ( w - {w}^{′} ) ) \qquad ( 8 )$$

In Expression (8), if the distance d(w, w′) between the first biometric w and the second biometric w′ is within a range of the error correction capability, the following holds.

$${x}^{′} = Decode ( Encode ( x ) ) = x \qquad ( 9 )$$

The restored signing key x′ (=x), since it is a secret key, may be discarded after use, for security reasons.

The certificate holder 120 generates a signature a for the challenge c using the restored signing key x′ (Step 4). The certificate holder 120 generates a certificate presentation (VP) including the signature a and transmits it to the certificate verifier 130 (Step 5).

The certificate verifier 130 generates a challenge c uniformly at random and transmits it to the certificate holder 120 (Step 1).

On reception of the certificate presentation (VP) including the signature a, the certificate verifier 130 verifies the certificate presentation (VP) (Step 2). Furthermore, the certificate verifier 130 verifies the signature a using the verification key v and the signature included in the certificate presentation (VP) (Verify (v, c, a)) (Step 3).

The process (Step 2) in the certificate verifier 130 verifies that the verification key (public key) v was generated for the certificate (VC) and that the signature a was generated for the certificate presentation (VP).

The process (Step 3) in the certificate verifier 130 makes it possible to verify that the second biometric information w′ of the same person as the first biometric information w used in the certificate issuer 110 was presented by the certificate holder 120.

When processes (Steps 2 and 3) in the certificate verifier 130 are combined, it is possible to verify that the biometric information of the same person was presented both at the time of certificate issuance and at the time of certificate presentation.

According to the present disclosure, the first and second biometric information w and w′ obtained by the certificate issuer 110 and certificate holder 120, respectively, are not transmitted to the certificate verifier 130, and the auxiliary data s generated based on the first biometric information w and the signing key x is also not transmitted to the certificate verifier 130. A possibility of the first biometric information w and the signing key x being leaked from the auxiliary data s is sufficiently low to ensure security.

The following describes an example case in which a Schnorr signature is used as the signature described above.

The certificate issuer 110 generates a pair of a private key (signing key) x and a public key (verification key) v, using the following key generation algorithm.

p and q are prime numbers, where q|(p−1) (q is a divisor of p−1).

g is a generating element of an order q of a multiplication group Zₚ*. i.e., g\hat{ }q≡1 (mod p), where \hat{ } is a power operator, and mod is a modulo operator.

The certificate issuer 110 selects a private key x uniformly at random.

$$x {←}^{R} {Z}_{q} \qquad ( 10 )$$

where Z_{q}=Z/qZ: a set of integers between 0 and q, x∈[0,q−1).

The symbol (notation) “←^{R}” represents a uniform random selection from an information source (in this case, Z_{q}).

A public key v may be calculated according to the following Equation (11).

$$v = {g}^{⋀} x mod p \qquad ( 11 )$$

The public key may be a set of p, q, g, and v. Alternatively, p, q, and g may be shared by each apparatus as common parameters, and the public key may be v.

The certificate issuer 110 generates a certificate including the verification key v in the claim and transmits it to the certificate holder 120.

In the certificate holder 120, a difference between the auxiliary data s(=Encode(x)+w) and the second biometric w′ are supplied as input to the decoding function Decode to restore a signing key x′.

$${x}^{′} = Decode ( s - {w}^{′} ) \qquad ( 12 )$$

Using the restored signing key x′, a signature for a challenge c is generated, as follows.

k (random number) is selected uniformly at random from an information source.

$$k {←}^{R} {Z}_{q} \qquad ( 13 )$$

r is computed by power multiplying g by k.

$$r = {g}^{⋀} k mod p \qquad ( 14 )$$

Hash function H outputs a hashed value e of r and c.

$$e = H ( r , c ) \qquad ( 15 )$$

Using e, s is computed as follows.

$$s = k - e * {x}^{′} mod q \qquad ( 16 )$$

Using e and s, a signature

$$σ = ( e , s ) \qquad ( 17 )$$

is output.

The certificate verifier 130 obtains the verification key v include d in the certificate of the certificate presentation an performs a signature verification: Verify (v, c, σ) (v=g\hat{ }x mod p: public key), for a signature σ=(e, s) and message c, as follows.

The certificate verifier 130 computes

$${r}^{′} = ( {g}^{⋀} s ) ( {v}^{⋀} e ) mod p \qquad ( 18 )$$

and, if

$$e = H ( {r}^{′} , c ) \qquad ( 19 )$$

holds, then returns 1 (accepted), and else (condition (19) does not holds), returns 0 (not accepted).

The following is also true as for Verify(v, c, σ).

If

$$g \hat{} k = ( g \hat{} s ) * ( v \hat{} e ) mod p \qquad ( 20 )$$

holds, then the certificate verifier 130 may return 1 (accepted). If it does not hold, the certificate verifier 130 may return 0 (not accepted). That is, if the restored signing key x′ is equal to the original signing key x, regarding

$${( g \hat{} s )}^{*} ( v \hat{} e ) = g \hat{} \{ ( k e * {x}^{′} ) + x * e mod q \} mod p \qquad ( 21 )$$

a right-hand side of Equation (21) is g\hat{ }k mod p. If the restored signing key x′ is not equal to the original signing key x, the right side of Equation (21) is not g\hat{ }k mod p.

A fuzzy signature scheme, which treats biometric information as fuzzy data to generate a signature, is known (Reference Literatures 6 and 7).

In a key generation stage of the fuzzy signature scheme, when a security parameter (key length) A and fuzzy data w such as biometric information are input to a key generation algorithm KeyGen, a public key (verification key) v is generated. At that time, a Key parameter (e.g., a linear sketch) kp may be output.

$$v ← KeyGen ( λ , w ) \qquad ( 22 )$$

In a signature stage, the fuzzy data w′ and a message M are input to a signature algorithm Sign to generate a signature σ.

$$σ ← Sign ( {w}^{′} , M ) \qquad ( 23 )$$

The Key parameter kp output during the key generation may be additionally input to a signing algorithm.

In a signature verification stage, the verification key v, the message M, and signature σ are input to the verification algorithm Verify, which outputs an acceptance (e.g., 1) or rejection (e.g., 0) as the signature a verification result.

$$1 / 0 ← Verify ( v , M , σ ) \qquad ( 24 )$$

Using the verification key v generated by the key generation algorithm from the fuzzy data w∈X and verifying the signature σ generated for the message M using the fuzzy data w′∈W (the distance d(w, w′) between w and w′ is less than a threshold θ) that is close enough to the fuzzy data w, the result is acceptance.

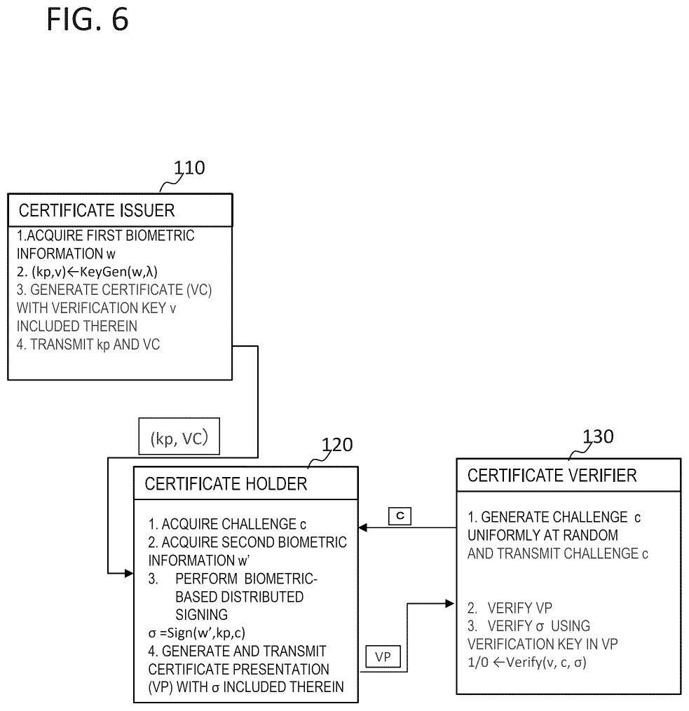

FIG. 6 is a simplified schematic diagram of another example of operations in the system of the embodiment of the present disclosure. FIG. 6 illustrates an example using the fuzzy signature scheme. Numbers in each apparatus represent processing steps. In the following, the processing step number in each apparatus in FIG. 6 is added in a parentheses at the end of the sentence describing the processing of each apparatus (not necessarily corresponding to the steps in FIG. 4).

The certificate issuer 110 acquires first biometric w (Step 1) and generates a first Key parameter kp and a verification key v using the first biometric w (fuzzy data) (Step 2).

$$( kp , v ) ← KeyGe n ( w , λ ) \qquad ( 25 )$$

The certificate issuer 110 generates a certificate (VC) including the verification key v in a claim (Step 3) and transmits the first Key parameter kp and the certificate (VC) to the certificate holder 120 (Step 4). As described above, the auxiliary data s may be a key parameter, and thus the first Key parameter kp may be referred to as the first auxiliary data.

The certificate holder 120 acquires second biometric information w′ (Step 2).

The certificate holder 120 generates a signature for the challenge c using the second biometric w′ and the first Key parameter kp by performing biometric-based distributed signing process (biometric-based distributed signature generation process) (Step 3).

$$σ = Sign ( {w}^{′} , c , kp ) \qquad ( 26 )$$

The certificate holder 120 generates a certificate presentation (VC) with the signature σ therein and transmits the certificate presentation (VC) to the certificate verifier 130 (Step 4).

In the biometric-based distributed signing process, a signature is generated by an entity having biometric information and another entity having a key parameter, without restoring the signing key. Although not limited thereto, the biometric-based distributed signing process may, for example, be implemented as a distributed process between two applications or as distributed signing where the biometric information acquisition part is provided on a separate apparatus.

The certificate verifier 130 generates a challenge c uniformly at random and transmits it to the certificate holder 120 (Step 1).

On reception of a certificate presentation (VC) including a signature a, the certificate verifier 130 verifies the certificate presentation (VC) (Step 2). Furthermore, the certificate verifier 130 verifies the signature σ using the verification key v and signature σ included in the certificate presentation (VC) (Verify (v, c, σ)) (Step 3).

The process (Step 2) in the certificate verifier 130 verifies that the public key v was generated for the certificate (VC) and the signature σ was generated for the certificate presentation (VP).

The process (Step 3) in the certificate verifier 130 enables verification that the second biometric information w′ of the same person as the first biometric information w used in the certificate issuer 110 was presented by the certificate holder 120.

When processes (Step 2 and Step 3) in the certificate verifier 130 are combined, it is possible to verify that the biometric information of the same person was presented at the time of certificate issuance and at the time of certificate presentation.

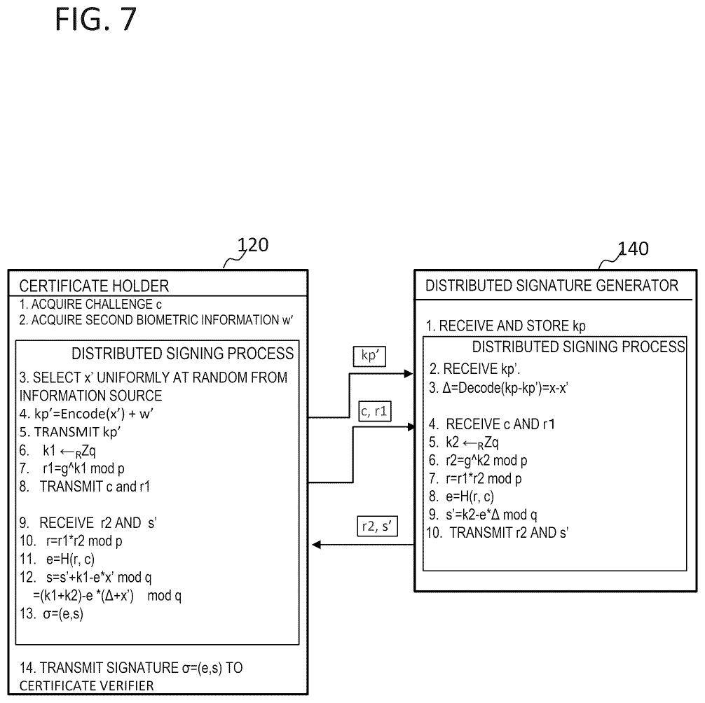

FIG. 7 illustrates an example of the biometric-based distributed signature generation as an example of application of the fuzzy signature scheme illustrated in FIG. 6.

The certificate holder 120 obtains the challenge c generated by the certificate verifier 130 (Step 1). The certificate holder 120 acquires a second biometric information w′ (Step 2).

The certificate issuer 110 may compute a first Key parameter kp using the encoded value of the signing key x and the second biometric information w′, as with the auxiliary data described above:

$$kp = Encode ( x ) + w \qquad ( 27 )$$

In this case, the verification key v is a public key corresponding to the signing key x.

FIG. 7 illustrates biometric-based distributed signing process (biometric-based distributed signature generation process) using a Schnorr signature scheme. In FIG. 7, the biometric-based distributed signing process corresponds to generation of the signature σ=Sign(w′, c, kp) in Step 3 in the certificate holder 120 of FIG. 6. The distributed signature generator 140 may be made of an information processing apparatus (application apparatus) configured to perform the distributed signing process in cooperation with the signature generation part 125 of the certificate holder 120.

The signature generation part 125 of the certificate holder 120 obtains a first distributed key (secret key) x′ for distributed signing uniformly at random from an information source (Step 3), and using the second biometric information w′ and an encoded value of the first distributed key x′: Encode(x′), generates a second Key parameter kp′ as follows (Step 4).

$${kp}^{′} = Encode ( {x}^{′} ) + {w}^{′} \qquad ( 28 )$$

The signature generation part 125 of the certificate holder 120 transmits the second Key parameter kp′ to the distributed signature generator 140 (Step 5). The second Key parameter kp′ may be referred to as the second auxiliary data.

The distributed signature generator 140 obtains and stores the first Key parameter kp (=Encode(x)+w) generated by the certificate holder 120 (Step 1). The distributed signature generator 140 receives the second Key parameter kp′ transmitted from certificate holder 120 (Step 2) and decodes a difference (kp−kp′) between the first Key parameter and kp and the second Key parameter kp′ to obtain the key difference x−x′ (=Δ) (3).

$$\begin{matrix}Decode ( kp - {kp}^{′} ) = Decode ( Encode ( x ) + w - ( Encode ( {x}^{′} ) + {w}^{′} ) ) \\ = Decode ( Encode ( x - {x}^{′} ) + w - {w}^{′} )\end{matrix} \qquad ( 29 )$$

When a distance d(w, w′) between the first biometric w and the second biometric w′ is within a range of an error correction capability, then the following holds.

$$Δ = x - {x}^{′} \qquad ( 30 )$$

The key difference Δ between the signing key x and the first distributed key is called a second distributed key (secret key) for distributed signing.

The distributed signature generator 140 computes a signature for the challenge c using the second distributed key Δ, and transmits a part of the signature to the certificate holder 120. In the certificate holder 120, the part of the signature generated by the distributed signature generator 140 may be used to generate a signature σ for the challenge c with Δ+x′(=x) as the signing key. The following describes the biometric-based distributed signature generation (σ=Sign(w′, kp, c) in Step 3 of FIG. 6), using the Schnorr signature as an example.

The signature generation part 125 of the certificate holder 120, selects the first random number k1 uniformly at random (Step 6).

$$k 1 ← {}^{R} {Z}_{q} ( k 1 ∈ [ 0 , q - 1 ] ) ) \qquad ( 31 )$$

The signature generation part 125 of the certificate holder 120 obtains a value r1 by multiplying the generator element g by the first random number k1 (Step 7).

$$r 1 = g \hat{} k 1 mod p \qquad ( 32 )$$

The signature generation part 125 of the certificate holder 120 transmits the challenge c and r1 to the distributed signature generator 140 (Step 8).

The distributed signature generator 140 receives the challenge c and r1 transmitted from the certificate holder 120 (Step 4).

The distributed signature generator 140 selects a second random number k2 uniformly at random (Step 5).

$$k 2 ← {}^{R} {Z}_{q} ( k 2 ∈ [ 0 , q - 1 ] ) ) \qquad ( 33 )$$

The distributed signature generator 140 obtains a value r2 by power multiplying the generator element g by the second random number k2 (Step 6).

$$r 2 = g \hat{} k 2 mod p \qquad ( 34 )$$

The distributed signature generator 140 obtains a value r by multiplying r2 by r1 transmitted from certificate holder 120 (Step 7).

$$r = r 1 * r 2 mod p \qquad ( 35 )$$

The distributed signature generator 140 inputs r and the challenge c to hash function H to compute e (Step 8).

$$e = H ( r , c ) ( ∈ {{Z}_{q}}^{*} : set of integers of {Z}_{q} and prime to q ) \qquad ( 36 )$$

The distributed signature generator 140, using a value obtained by multiplying e by the second distributed key Δ and a second random number k2, computes s′ (Step 9).

$${s}^{′} = k 2 - e * Δmod q . \qquad ( 37 )$$

The signature (e, s′) may well be said to be a part of the distributed signature.

The distributed signature generator 140 transmits s′ (s′ is the second element of the signature (e, s′)) and r2 to the certificate holder 120 (10).

The signature generation part 125 of the certificate holder 120 receives s′ (a part of the signature) and r2 transmitted from the distributed signature generator 140 (Step 9).

The signature generation part 125 of the certificate holder 120 multiplies r2 (=g\hat{ }k2 mod p) transmitted from the distributed signature generator 140 by r1 (=g\hat{ }k1 mod p) (Step 10).

$$r = r 1 * r 2 mod p = g \hat{} ( k 1 + k 2 mod q ) mod p \qquad ( 38 )$$

The signature generation part 125 of the certificate holder 120 inputs r and the challenge c obtained in Equation (38) into the hash function H to obtain e (Step 11).

$$e = H ( r , c ) \qquad ( 39 )$$

The certificate holder 120, using s′ transmitted from the distributed signature generator 140, a value obtained by multiplying e obtained by Equation (39) by the first distributed key x′, and the first random number k1, computes s (Step 12).

$$\begin{matrix}s = {s}^{′} + k 1 - e * {x}^{′} mod q \\ = ( k 1 + k 2 ) - e * ( Δ + {x}^{′} ) mod q\end{matrix} \qquad ( 40 )$$

As described above, the certificate holder 120, in cooperation with the distributed signature generator 140, generates a signature σ=(e, s) for the challenge c based on the first distributed key x′ and the second distributed key Δ (Step 13). Since the second biometric information w′ and the first distributed key (private key) x′ (encoded value) obtained by the certificate holder 120 are combined and transmitted to the distributed signature generator 140 as the second Key parameter kp′, a possibility of the second biometric information w′ and the first distributed key (private key) x′ being forged or leaked is extremely low. In addition, since the second distributed key (private key) A generated by the distributed signature generator 140 is transmitted to the certificate holder 120 as s′ of the signature σ=(e, s′), the possibility of the second distributed key Δ being leaked is extremely low and security is ensured.

The certificate holder 120 transmits the signature σ=(e, s) to the certificate verifier 130 (FIG. 6) (Step 14).

In the certificate verifier 130, the signature acquisition part 133 receives the signature σ=(e, s). The signature verification part 136 of the certificate verifier 130 verifies correctness of the signature σ=(e, s) and the challenge c, using the verification key v (=g\hat{ }x mod p) included in the certificate. That is, the value r′ is obtained by power multiplying the generator element g by s and the verification key v by e.

$${r}^{′} = ( g \hat{} s ) * ( v \hat{} e ) mod p \qquad ( 41 )$$

The signature verification part 136 computes a hash value for r′ and the challenge c

$$H ( {r}^{′} , c ) \qquad ( 42 )$$

$$If e = H ( {r}^{′} , c ) \qquad ( 43 )$$

holds, the signature verification part 136 returns 1 (accepted) and if not, returns 0 (not accepted).

That is, for the right side of Equation (41),

$$g \hat{} s = g \hat{} \{ k 1 + k 2 - e * ( Δ + {x}^{′} ) mod q \} mod p \qquad ( 44 )$$

$$v \hat{} e = g \hat{} ( x * e mod q ) mod p \qquad ( 45 )$$

Therefore, r′ in Equation (41) is given by the following Equation (46).

$${r}^{′} = g \hat{} \{ k 1 + k 2 - e * ( Δ ) + e * ( x - {x}^{′} ) mod q \} mod p \qquad ( 46 )$$

If the following holds,

$$Δ = x - {x}^{′} mod q \qquad ( 47 )$$

then, the right side of Equation (46) is given as follows.

$${r}^{′} = g \hat{} ( k 1 + k 2 mod q ) mod p \qquad ( 48 )$$

Thus, r′ is equal to r obtained in Equation (38) (r′=r). Therefore,

$$H ( {r}^{′} , c ) = H ( r , c ) = e \qquad ( 49 )$$

holds and Verify (v, c, a) returns 1 (accepted).

On the other hand, if

$$x \neq {x}^{′} + Δmod q \qquad ( 50 )$$

then, from Equation (47), r′ differs from r obtained in Equation (38) (r′ #r), and therefore

$$e = H ( r , c ) \neq H ( {r}^{′} , c ) \qquad ( 51 )$$

Therefore, the signature verification part 136 (Verify (v, c, σ)) returns 0 (not accepted).

In the example of FIG. 6, the key difference Δ(=x−x′) is decoded by Decode (kp−kp′) in Equation (29), but the signing key x itself is not decoded. On the other hand, in the example in FIG. 5, by Decode (s−w′) in Equation (12), if the distance d (w, w′) between the first biometric w and the second biometric w′ is within a range of the error correction capability, the signing key x itself is decrypted as x′.

For the purpose of increasing security, a zero-knowledge proof (Non-Interactive zero-knowledge (NIZK)) about the first random number k1 may be provided from the certificate holder 120 to the distributed signature generator 140. In this case, the certificate holder 120 and the distributed signature generator 140 share a proof generation key and a proof verification key. For example, in FIG. 7, the certificate holder 120, computes r1 using the first random number k1 (Step 6 in the certificate holder 120 in FIG. 7) and then, from an instance of a proposition to be proved (having knowledge about the first random number k1) and an evidence (witness) that this proposition is correct, generates a proof (NIZK proof) (π1). The instance (r1) and the proof (π1) may be transmitted to the distributed signature generator 140. After receiving the instance (r1) and the proof (l 1), the distributed signature generator 140 may verify the proof (π1) using the proof verification key.

A non-interactive zero-knowledge proof of knowledge of the second random number k2 may be provided from the distributed signature generator 140 to the certificate holder 120. For example, in FIG. 7, the distributed signature generator 140 computes r2 using the second random number k2 (Step 6 in the distributed signature generator 140 in FIG. 7) and then transmits an instance of a proposition to be proved (instance of having knowledge about the first random number k2) and then, from the instance (r2) of the proposition to be proved and an evidence that this proposition is correct, a proof (π2) is generated. The instance (r2) and the proof (π2) may be transmitted to the certificate holder 120. After receiving the instance (r2) and proof (π2), the certificate holder 120 may verify the proof (π2) using the proof verification key. The certificate holder 120 may decommit to the instance (R2) and proof (π2), and the distributed signature generator 140 may verify the proof (π2) after the commitment is released (reference may be made to Reference Literature 4).

The above description of the example embodiment was given using a two-party Schnorr signature, but the same can be applied to ECDSA (Elliptic Curve Digital Signature Algorithm: Elliptic Curve DSA) as a biometric distributed signature generation process (reference may be made to Reference Literature 4).

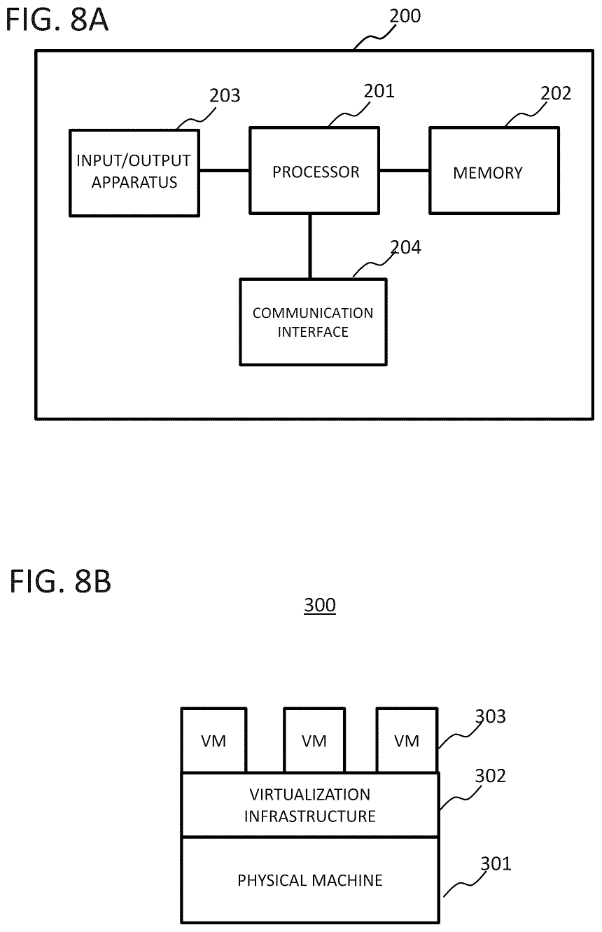

FIG. 8A is a schematic diagram illustrating an example in which each apparatus (110, 120/140, 130) of the certificate verification system 100 described above is implemented by a computer that includes communication functions and can be connected to each other via a network(s). In FIG. 8A, each apparatus (110, 120/140, 130) includes a processor(s) 201, a storage apparatus(es) 202, an input/output apparatus(es) 203, and a communication interface(s) 204. The storage apparatus 202 may include a semiconductor storage(s) such a RAM (Random Access Memory), ROM (Read Only Memory), or EEPROM (Electrically Erasable and Programmable ROM), HDD (Hard Disk Drive), CD (Compact Disc), DVD (Digital Versatile Disc), or the like. The processor 201 is configured to execute a program (instructions) (not shown) stored in memory apparatus 202 to realize processing or functions of each apparatus. The input/output apparatus 203 may include a keyboard and display. For example, the certificate holder 120 may be configured to output a result of verification by the certificate verifier 130 to an output apparatus such as a display. In the certificate issuer 110 and the certificate holder 120 that acquire biometric information, the input/output apparatus 203 may include a sensor(s) configured to acquire biometric information. In this case, the sensor may be an image sensor (camera) configured to capture biometric information of a face, iris, etc., a fingerprint sensor configured to capture biometric information of a fingerprint, or a near-infrared camera configured to capture light transmitted through a finger with an LED (Light Emitting Diode) that emits near-infrared light, for example, for finger veins. The sensor may be a removable sensor, for example, a USB (Universal Serial Bus) apparatus. The communication interface 204 may include a network interface card(s), transceiver(s), or the like, and may be configured to communicate with other apparatuses, each other, via a LAN (Local Area Network), WAN (Wide Area Network) such as the Internet, wireless LAN, mobile communication network, or the like. The communication interface 204 may also include an interface configured to communicatively connect to an external sensor (such as a Bluetooth (registered trademark) connected sensor) in the certificate issuer 110 and/or the certificate holder 120, and to receive biometric information acquired by the external sensor.

FIG. 8B schematically illustrates an example in which the apparatuses (110, 120/140, 130) of the certificate verification system 100 described above are implemented as virtual machines using server virtualization technology. Multiple virtual machine (Virtual Machine) VM 303 run on a virtualization infrastructure 302 such as a hypervisor implemented on a server physical machine 301. One or more of the apparatuses (110, 120/140, 130) of the certificate verification system 100 may be implemented as virtual machine VMs 303. A virtual server environment is provided in which multiple servers are running, although physically it is one server. Each virtual machine VM is preferably configured to run in an isolated environment in memory space. In this case, in the virtual machine VM, the program that realizes the processing of one of the apparatuses (110, 120/140, 130) runs on the virtual OS (Operating System) of the virtual machine. The virtual machine VM 303 that virtually realizes any of the apparatuses (110, 120/140, 130) may be configured to communicate and connect to other virtual machines via a virtual network, or via the physical interface (communication interface) of the physical machine 301 to a LAN, WAN such as the Internet It may be configured to communicate and connect with other apparatuses among the apparatuses (110, 120/140, 130) via a LAN, Internet, etc. In this case, the plurality of virtual machine VMs 303 need not be executed on the same physical machine but may be configured to communicate and connect with virtual machine VMs executed on other physical machines.

The first biometric information w and the second biometric information w′ may be a binary vector, a real number vector, or an integer vector.

In the above, example systems for processing based on biometric information are described, but the present disclosure is not limited to biometric information, and can also be realized using fuzzy information other than biometric information. For example, the present disclosure may be applied to PUF (Physically Unclonable Function (PUF): a technology that uses individual differences that occur in a manufacturing process of such as IC chips, to identify individuals (IC chips) like human fingerprints, etc.).

The following lists describes supplementary notes (notes) of the above examples and embodiments (but not limited thereto).

(Note 1) A verifiable certificate system including: a certificate issuer, a certificate holder, and a certificate verifier.

The certificate issuer includes: a memory storing instructions; and a processor configured to execute the instructions to:
generate first auxiliary data using a first signing key and first biometric information;
generate a certificate including a verification key corresponding to the first signing key; and
transmit the certificate and the first auxiliary data to the certificate holder.

The certificate holder includes: a memory storing instructions; and a processor configured to execute the instructions to:
acquire second biometric information;
receive the certificate and the first auxiliary data transmitted from the certificate holder;
generate a signature using the second biometric information and the first auxiliary data;
generate a certificate presentation using the certificate; and
transmit the certificate presentation and the signature to the certificate verifier.

The certificate include s: a memory storing instructions; and a processor configured to execute the instructions to:
receive the certificate presentation and signature transmitted from the certificate holder;
verify the certificate included in the certificate presentation; and verify the signature using the verification key included in the certificate.
   (Note 2) In the verifiable certificate system of Note 1, the processor included in the certificate verifier is configured to:
generate a challenge; and
transmit the challenge to the certificate holder.

The processor included in the certificate holder is configured to:
receive the challenge transmitted from the circuit verifier;
generate the signature for the challenge with a signing key restored using the first auxiliary data and the second biometric information; and
transmit, to the certificate verifier, the signature and the certificate presentation separately or simultaneously, or the certificate presentation with the signature included therein.
   (Note 3) In the verifiable certificate system of Note 1 or 2, the processor included in the certificate issuer is configured to
generate the first auxiliary data using a first operation of an encoded value of the first signing key and the first biometric information.

The processor included in the certificate holder is configured to:
restore a signing key by decoding a value obtained by a second operation of the first auxiliary data and the second biometric information; and
generate the signature with the signing key restored.
   (Note 4) In the verifiable certificate system of any of Notes 1 to 3, the processor included in the certificate verifier is configured to:
generate a challenge; and
transmit the challenge to the certificate holder.

The processor included in the certificate holder is configured to:
based on the second biometric information and the first auxiliary data, generates, using a distributed signing process, the signature for the challenge transmitted from the certificate verifier.

The processor included in the certificate verifier is configured to
verify the signature using the verification key included in the certificate.
   (Note 5) In the verifiable certificate system of Note 4, the processor included in the certificate issuer is configured to:
generate the first auxiliary data using a first operation of an encoded value of the first signing key and the first biometric information,
wherein the processor included in the certificate holder is configured to:
generate a first distributed key for distributed signing; and
generate a second auxiliary data by a first operation of the encoded value of the first distributed key and the second biometric information.

The system further includes a distributed signature generation processor configured to cooperate with the certificate holder to perform a distributed signing process, the distributed signature generation processor configured to:
obtain the first auxiliary data from the certificate issuer;
obtain the second auxiliary data from the certificate holder,
decode a value obtained using a second operation of the auxiliary data and the second auxiliary data to obtain a key difference between the signing key and the first distributed key as a second distributed key for distributed signing;
generate a second distributed signature for the challenge with the second distributed key; and
transmit the second distributed signature for the challenge to the certificate holder.

The processor included in the certificate holder is configured to: receive the second distributed signature for the challenge with the second distributed key;
generate a first distributed signature for the challenge with the first distributed key; and
using at least the second distributed signature for the challenge with the second distributed key and the first distributed key, generate a signature for the challenge with a signature key corresponding to a sum of the first distributed key and the second distributed key.
   (Note 6) A method of verification for a verifiable certificate system including a certificate issuing node, a certificate holding node, and a certificate verifying node,
the method comprising, by the certificate issuing node:
generating first auxiliary data using a first signing key and first biometric information;
generating a certificate including a verification key corresponding to the first signing key; and
transmitting the certificate and the first auxiliary data are sent to the certificate holding node,
the method further comprising, by the certificate holding node:
obtaining second biometric data;
receiving the certificate and the first auxiliary data transmitted from the certificate holding node;
generating a signature using the second biometric information and the first auxiliary data;
generating a certificate presentation using the certificate; and
transmitting the certificate presentation and the signature to the certificate verifying node,
the method further comprising, by the certificate verifying node:
receiving the certificate presentation and the signature transmitted from the certificate holding node;
verifying the certificate included in the certificate presentation; and
verifying the signature using the verification key included in the certificate.
   (Note 7) The method of Note 6, comprising, by the certificate issuing node:
generating a challenge; and
transmitting the challenge to the certificate holder, and
wherein the method comprises, by the certificate holding node:
receiving the challenge transmitted from the certificate verifying node;
generating a signature for the challenge using a signing key restored using the second biometric and the first auxiliary data; and
transmitting, to the certificate verifying node, the signature and the certificate presentation separately or simultaneously, or the certificate presentation with the signature included therein.
   (Note 8) The method of Note 6 or 7, comprising, by the certificate issuing node:
generating the first auxiliary data using a first operation of an encoded value of the first signing key and the first biometric information,
the method comprises, by the certificate holding node:
restoring a signing key by decoding a value obtained by a second operation of the auxiliary data and the second biometric information; and
generating the signature with the signing key restored.
   (Note 9) The method of any one of Notes 6 to 8, comprising, by the certificate verifying node:
generating a challenge; and
transmitting the challenge to the certificate holding node,
wherein the method comprises, by the certificate holding node:
receiving the challenge transmitted from the certificate verifying node;
based on the second biometric information and the first auxiliary data, generating, using a distributed signing process, the signature for the challenge transmitted from the certificate verifying node, and
wherein the method comprises, by the certificate verifying node:
verifying the signature using the verification key included in the certificate presentation.
   (Note 10) The method of Note 9, comprising, by the certificate issuing node:
generating the first auxiliary data using a first operation of an encoded value of the first signing key and the first biometric information,
wherein the method comprises, by the certificate holding node:
generating a first distributed key for distributed signing; and
generating a second auxiliary data using a first operation of the encoded value of the first distributed key and the second biometric information,
wherein the system further includes a distributed signature generation node configured to cooperate with the certificate holding node to perform a distributed signing process,
the method comprising, by the distributed signature generation node to:
obtaining the first auxiliary data from the certificate issuing node;
obtaining the second auxiliary data from the certificate holding node;
decoding a value obtained using a second operation of the first auxiliary data and the second auxiliary data to obtain a key difference between the fist signing key and the first distributed key as a second distributed key for distributed signing;
generating a second distributed signature for the challenge with the second distributed key; and
transmitting the second distributed signature for the challenge to the certificate holding node,
wherein the method comprises, by the certificate holding node:
receiving the second distributed signature for the challenge with the second distributed key; and
using at least the second distributed signature and the first distributed key, generating a signature for the challenge with a signature key corresponding to a sum of the first distributed key and the second distributed key.
   (Note 11) A non-transitory medium storing a program for causing at least the first through third processing apparatuses to perform processing of a certificate issuer, a certificate holder, and a certificate verifier included in a verifiable certificate system,
wherein the processing, by the first processing apparatus, includes:
generating first auxiliary data using a first signing key and first biometric information;
generating a certificate including a verification key corresponding to the first signing key; and
transmitting the certificate and the first auxiliary data to the second processing apparatus,
wherein the processing, by the second processing apparatus, includes:
obtaining second biometric information;
generating a signature using the second biometric information and the first auxiliary data;
generating a certificate presentation from the certificate; and transmitting the certificate presentation and the signature to the third processing apparatus, and
wherein the processing, by the third processing apparatus, includes:
verifying the certificate from the certificate presentation; and verifying the signature using the verification key included in the certificate.
[Reference Literature 1] OpenID for Verifiable Presentations—draft 20 (the internet <URL> https://openid.net/specs/openid-4-verifiable-presentations-1_0.html)
[Reference Literature 2] Dodis, Yevgeniy/Reyzin, Leonid/Smith, Adam. “Fuzzy Extractors: How to Generate Strong Keys from Biometrics and Other Noisy Data.”, EUROCRYPT 2004.
[Reference Literature 3] Nicolosi, Antonio, et al. “Proactive Two-Party Signatures for User Authentication.” NDSS. 2003.
[Reference Literature 4] Lindell, Yehuda. “Fast secure two-party ECDSA signing.” Advances in Cryptology-CRYPTO 2017: 37th Annual International Cryptology Conference, Santa Barbara, CA, USA, Aug. 20-24, 2017, Proceedings, Part II 37. Springer International Publishing, 2017
[Reference Literature 5] Japanese Non-Examined Patent Publication No. 2021-087167.
[Reference Literature 6] Japanese Patent No. 5707311
[Reference Literature 7] WO 2020/174516

The disclosures in each of Non-Patent Literature 1 and Reference Literatures 1 to 7 shall be incorporated herein by reference. Within the framework of the disclosure of this application (including the scope of claims), furthermore, based on the basic technical concept, change, adjustment, and combination of embodiments or examples are possible. In addition, various combinations and selections of various disclosed elements (including each element of each claim, each element of each example, each element of each drawing, etc.) are possible within the framework of the claims. In other words, the present disclosure includes, as a matter of course, various transformations and modifications that those skilled in the art would be able to make in accordance with the entire disclosure and technical concept, including the scope of claims.

What is claimed is:

1. A system including:
a certificate issuer;
a certificate holder; and
a certificate verifier,
wherein the certificate issuer includes:
a communication interface configured to communicate at least with the certificate holder;
a memory configured to store instructions; and
a processor configured to execute the instructions to:
generate first auxiliary data using a first signing key and first biometric information;
generate a certificate including a verification key corresponding to the first signing key; and
transmit the certificate and the first auxiliary data to the certificate holder,
wherein the certificate holder includes:
a communication interface configured to communicate at least with the certificate issuer and the certificate verifier;
a memory configured to store instructions; and
a processor configured to execute the instructions to:
acquire second biometric information;
receive the certificate and the first auxiliary data transmitted from the certificate holder;
generate a signature using the second biometric information and the first auxiliary data;
generate a certificate presentation using the certificate; and
transmit the certificate presentation and the signature to the certificate verifier, and
wherein the certificate verifier includes:
a communication interface configured to communicate at least with the certificate holder;
a memory configured to store instructions; and
a processor configured to execute the instructions to:
receive the certificate presentation and signature transmitted from the certificate holder;
verify the signature using the verification key included in the certificate presentation.

2. The system according to claim 1, wherein the processor included in the certificate verifier is configured to:
generate a challenge; and
transmit the challenge to the certificate holder, and
wherein the processor included in the certificate holder is configured to:
receive the challenge transmitted from the circuit verifier;
generate the signature for the challenge with a signing key restored using the first auxiliary data and the second biometric information; and
transmit, to the certificate verifier, the signature and the certificate presentation separately or simultaneously, or the certificate presentation with the signature included therein.

3. The system according to claim 1, wherein the processor included in the certificate issuer is configured to
generate the first auxiliary data using a first operation of an encoded value of the first signing key and the first biometric information, and
wherein the processor included in the certificate holder is configured to:
restore a signing key by decoding a value obtained by a second operation of the first auxiliary data and the second biometric information; and
generate the signature with the signing key restored.

4. The system according to claim 3, wherein the first operation includes a composition operation of the encoded value of the first signing key and the first biometric information, and
wherein the second operation includes a difference operation between the first auxiliary data and the second biometric information.

5. The system according to claim 1, wherein the processor included in the certificate verifier is configured to:
generate a challenge; and
transmit the challenge to the certificate holder,
wherein the processor included in the certificate holder is configured to
based on the second biometric information and the first auxiliary data, generates, using a distributed signing process, the signature for the challenge transmitted from the certificate verifier, and
wherein the processor included in the certificate verifier is configured to
verify the signature using the verification key included in the certificate presentation.

6. The system according to claim 5, wherein the processor included in the certificate issuer is configured to:
generate the first auxiliary data using a composition operation of an encoded value of the first signing key and the first biometric information,
wherein the processor included in the certificate holder is configured to:
generate a first distributed key for distributed signing; and
generate a second auxiliary data using a first operation of the encoded value of the first distributed key and the second biometric information,
wherein the system further includes a distributed signature generation processor configured to cooperate with the certificate holder to perform a distributed signing process, the distributed signature generation processor configured to:
obtain the first auxiliary data from the certificate issuer;
obtain the second auxiliary data from the certificate holder,
decode a value obtained using a second operation of the auxiliary data and the second auxiliary data to obtain a key difference between the signing key and the first distributed key as a second distributed key for distributed signing;
generate a second distributed signature for the challenge with the second distributed key; and
transmit the second distributed signature for the challenge with the second distributed key to the certificate holder,
wherein the processor included in the certificate holder is configured to:
receive the second distributed signature for the challenge with the second distributed key; and
using at least the second distributed signature for the challenge with the second distributed key and the first distributed key, generate a signature for the challenge with a signature key corresponding to a sum of the first distributed key and the second distributed key.

7. The system according to claim 6, wherein the processor included in the certificate holder is configured to:
generate a first distributed signature for the challenge with the first distributed key; and
generate the signature for the challenge with a signature key corresponding to the sum of the first distributed key and the second distributed key, by composition of the second distributed signature for the challenge with the second distributed key received from the distributed signature generation processor and the first distributed signature for the challenge with the first distributed key.

8. The system according to claim 6, wherein the first operation includes a composition operation of the encoded value of the signing key and the first biometric information, and
wherein the second operation includes a difference operation between the auxiliary data and the second biometric information.

9. A method of verification for a system including a certificate issuing node, a certificate holding node, and a certificate verifying node,
the method comprising, by the certificate issuing node:
generating first auxiliary data using a first signing key and first biometric information;
generating a certificate including a verification key corresponding to the first signing key; and
transmitting the certificate and the first auxiliary data are sent to the certificate holding node,
the method further comprising, by the certificate holding node:
obtaining second biometric data;
receiving the certificate and the first auxiliary data transmitted from the certificate holding node;
generating a signature using the second biometric information and the first auxiliary data;
generating a certificate presentation using the certificate; and
transmitting the certificate presentation and the signature to the certificate verifying node,
the method further comprising, by the certificate verifying node:
receiving the certificate presentation and the signature transmitted from the certificate holding node;
verifying the certificate included in the certificate presentation; and
verifying the signature using the verification key included in the certificate.

10. The method according to claim 9, comprising, by the certificate verifying node:
generating a challenge; and
transmitting the challenge to the certificate holder, and
wherein the method comprises, by the certificate holding node:
receiving the challenge transmitted from the certificate verifying node;
generating a signature for the challenge using a signing key restored using the second biometric and the first auxiliary data; and
transmitting, to the certificate verifying node, the signature and the certificate presentation separately or simultaneously, or the certificate presentation with the signature included therein.

11. The method according to claim 9, comprising, by the certificate issuing node:
generating the first auxiliary data using a first operation of an encoded value of the first signing key and the first biometric information,
the method comprises, by the certificate holding node:
restoring a signing key by decoding a value obtained by a second operation of the first auxiliary data and the second biometric information; and
generating the signature with the signing key restored.

12. The method according to claim 11, wherein the first operation includes a composition operation of the encoded value of the first signing key and the first biometric information, and
wherein the second operation includes a difference operation between the first auxiliary data and the second biometric information.

13. The method according to claim 9, comprising, by the certificate verifying node:
generating a challenge; and
transmitting the challenge to the certificate holding node,
wherein the method comprises, by the certificate holding node:
receiving the challenge transmitted from the certificate verifying node;
based on the second biometric information and the first auxiliary data, generating, using a distributed signing process, the signature for the challenge transmitted from the certificate verifying node, and
wherein the method comprises, by the certificate verifying node:
verifying the signature using the verification key included in the certificate presentation.

14. The method according to claim 13, comprising, by the certificate issuing node:
generating the first auxiliary data using a first operation of an encoded value of the first signing key and the first biometric information,
wherein the method comprises, by the certificate holding node:
generating a first distributed key for distributed signing; and
generating a second auxiliary data using a first operation of the encoded value of the first distributed key and the second biometric information,
wherein the system further includes a distributed signature generation node configured to cooperate with the certificate holding node to perform a distributed signing process,
the method comprising, by the distributed signature generation node to:
obtaining the first auxiliary data from the certificate issuing node;
obtaining the second auxiliary data from the certificate holding node;
decoding a value obtained using a second operation of the first auxiliary data and the second auxiliary data to obtain a key difference between the fist signing key and the first distributed key as a second distributed key for distributed signing;
generating a second distributed signature for the challenge with the second distributed key; and
transmitting the second distributed signature for the challenge to the certificate holding node,
wherein the method comprises, by the certificate holding node:
receiving the second distributed signature for the challenge with the second distributed key; and
using at least the second distributed signature and the first distributed key, generating a signature for the challenge with a signature key corresponding to a sum of the first distributed key and the second distributed key.

15. The method according to claim 14, comprising, by the certificate holding node:
generating a first distributed signature for the challenge with the first distributed key; and
generating the signature for the challenge with a signature key corresponding to the sum of the first distributed key and the second distributed key, by composition of the second distributed signature with the second distributed key for the challenge received from the distributed signature generation node and the first distributed signature for the challenge with the first distributed key.

16. The method according to claim 14, wherein the first operation includes a composition operation of the encoded value of the fist signing key and the first biometric information, and
wherein the second operation includes a difference operation between the first auxiliary data and the second biometric information.

17. A non-transitory computer readable recording medium storing one or more programs that cause at least the first through third processing apparatuses to perform processing of a certificate issuer, a certificate holder, and a certificate verifier included in a system,
wherein the processing, by the first processing apparatus, includes:
generating first auxiliary data using a first signing key and first biometric information;
generating a certificate including a verification key corresponding to the first signing key; and
transmitting the certificate and the first auxiliary data to the second processing apparatus,
wherein the processing, by the second processing apparatus, includes:
obtaining second biometric information;
generating a signature using the second biometric information and the first auxiliary data;
generating a certificate presentation from the certificate; and transmitting the certificate presentation and the signature to the third processing apparatus, and
wherein the processing, by the third processing apparatus, includes:
verifying the certificate from the certificate presentation; and verifying the signature using the verification key included in the certificate.
